(19) United States
(12) Patent Application Publication
(10) Pub. No.: US 2012/0173316 A1
(43) Pub. Date: Jul. 5, 2012

(54) System And Method For Social Networking

(76) Inventor: Jason Stephans, Paramus, NJ (US)

(21) Appl. No.: 12/983,176

(22) Filed: Dec. 31, 2010

(51) Int. Cl. G06Q 99/00; G06Q 30/00; G06F 15/16

(52) U.S. Cl. 705/14.4; 709/206

(57) ABSTRACT

A method for facilitating social networking includes receiving and storing personal information from a member of a website, which includes a publicly displayed identifier such as that individual's vehicle license plate number. An advertisement suitable for public display (e.g. a bumper sticker) is used to advertise to other individuals that the first individual is a member of the website. A query is received at the website, via a network, from a second individual in accordance with the advertisement; the query includes the publicly displayed identifier. The method further includes receiving contact information from the second individual; providing to the second individual at least a portion of the personal information of the first individual; providing the second individual with the opportunity to send his/her contact information to the first individual; and providing the first individual with the opportunity to make a social networking connection with the second individual.

### FIELD OF THE DISCLOSURE

This disclosure relates to social networking, and more particularly to a social networking or dating site which is associated with an individual's publicly available identification (e.g. a vehicle license plate number(s) or other alpha numeric display (identifier) that may either be selected by the individual or randomly assigned to their vehicle).

### BACKGROUND OF THE DISCLOSURE

Websites where individuals may make personal connections (generally called social networking sites or dating sites) have become popular recently, particularly with widespread use of portable devices for accessing the Web. A member of a social networking site may make contact with another person they might not have met otherwise.

An individual driving a vehicle is generally anonymous; although the vehicles' plate number is on public display, another individual generally cannot discern the driver's name. Furthermore, one driver on the road cannot personally meet and greet another driver as they might if they were both on foot. It is desirable to implement a system where seeing an individual driving a vehicle can lead to social networking with that individual.

### SUMMARY OF THE DISCLOSURE

In accordance with the disclosure, a system and method are provided for facilitating social networking, particularly between individuals on the road in different vehicles.

According to a first aspect of the disclosure, a method for facilitating social networking includes receiving and storing personal information from a first individual to create a profile (a member of a website); this information includes a publicly displayed identifier associated with the first individual, such as that individual's vehicle license plate number. An advertisement suitable for public display (e.g. a bumper sticker) is delivered to the first individual, or available via a retail channel, which advertises to other individuals that the first individual is a member of the website. A query is received at the website, via a network, from a second individual (a contact person) in accordance with the advertisement; the query includes the publicly displayed identifier. The method further includes receiving contact information from the second individual; retrieving the personal information of the first individual (e.g. at a minimum, confirming that the first individual is a member of the website) in accordance with the query; and providing to the second individual at least a portion of the personal information of the first individual depending upon the first individual's privacy settings with the website. This method typically is performed using a computing device (a server hosting the website) configured to communicate with the first individual and with the second individual via the network. Further, depending upon the first individual's review of the contact person's information, the first individual may choose to make a social networking connection with the contact person via the means provided for on the website.

The method may also include establishing a member profile for the second individual in accordance with the received contact information; and storing the profile. The member profile for the second individual is advantageously established prior to providing to the second individual personal information of the first individual.

According to another aspect of the disclosure, the received personal information does not include a publicly displayed identifier, and an identifier may either be selected by the individual or randomly assigned to their vehicle.

The personal information of the first individual (e.g. at a minimum, confirming that the first individual is a member of the website) is retrievable using the identifier. An advertisement suitable for public display is delivered to the first individual, or available via a retail channel, advertising to other individuals that the first individual is a member of the website; the advertisement as displayed includes the identifier or information associated therewith. A query is received from a second individual, a query in accordance with the advertisement; the query includes the displayed identifier or information associated therewith.

According to a further aspect of the invention, a system for facilitating social networking includes a server configured to perform the above-described functions; the server hosts a website whose name, initials, and/or logo is on the advertisement, so that the first individual and second individual access the website and submit personal information thereto.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1A schematically illustrates a bumper sticker used by a subscriber to a social networking website in accordance with an embodiment of the disclosure.

FIG. 1B schematically illustrates a bumper sticker used by a subscriber to a social networking website in accordance with another embodiment of the disclosure.

FIG. 2 is a flowchart illustrating a method in which contact between persons is facilitated using a website embodying the disclosure.

FIG. 3 schematically illustrates a system for facilitating social networking in accordance with an embodiment of the disclosure.

FIG. 4 schematically illustrates a system for facilitating social networking in accordance with another embodiment of the disclosure.

### DETAILED DESCRIPTION

A social networking website embodying the present disclosure is referred to herein, for convenience only, as “streetfriend.com.”

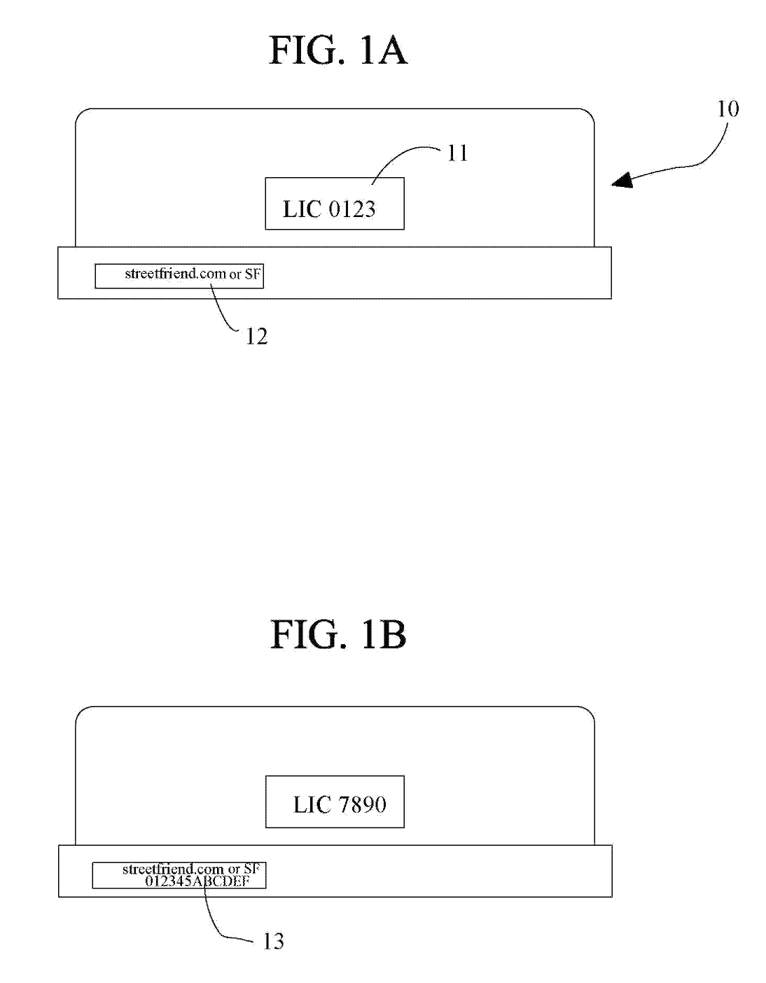

In an embodiment, the social networking site associates personal information of a member of the site with that member's license plate number. When an individual becomes a member of the site, s/he receives an identifier (e.g. an ID number) related to his/her license plate. As shown in FIG. 1A, a bumper sticker 12 placed on the member's vehicle 10 (preferably close to the license plate 11) advertises that the driver/owner of the vehicle is a member of the social networking site. If someone then wants to connect with that vehicle's owner, they may make a note of the license plate number, go to the streetfriend.com URL and can connect with that person.

Alternatively, if a member of the streetfriend.com site does not want to have their license plate used, a random membership number may be created that can be written on the sticker. The member then may place the sticker in any desired location on their vehicle (see FIG. 1B). In this embodiment, the member's streefriend.com identifier is independent of the license plate number; accordingly, a prospective contact person would need to make a note of the member's id number from the sticker, and then visit the URL streetfriend.com to connect with the streetfriend.com member.

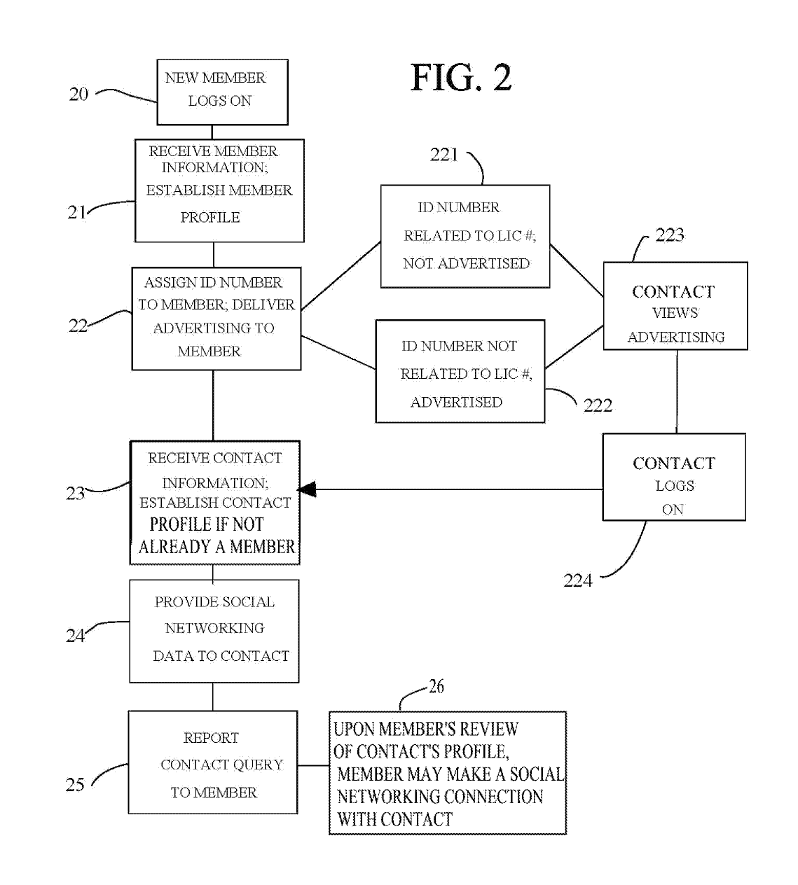

FIG. 2 is a flowchart with steps in a method carried out by a provider or administrator of the streetfriend.com site, in accordance with an embodiment of the disclosure. A person desiring to participate (that is, a prospective new member of the site) logs onto the site (step 20) and proceeds to provide various items of information about him/herself. The site receives the new member's information, and establishes a profile for the member based on that information (step 21). The site then generates an identifier (ID number) for the member, and (if desired) associates that identifier with a vehicle plate number in the member's profile; the site delivers an appropriate sticker to the member (step 22). The sticker may be delivered to the member offline (e.g. a physical bumper sticker sent by mail), may simply be presented to the member as a downloadable image which the member prints on a suitable (e.g. weather-resistant, adhesive) medium, or available via a retail channel.

As noted above, the member's streetfriend.com ID number may be linked to the member's license plate number, in which case (221) no other identifier need be advertised on the sticker. If the member's streetfriend.com ID number is not linked to the license plate number, then (222) the member's ID number (or another number associated with the ID number in the member's profile) is added to the sticker.

A person viewing the advertisement (step 223) and wishing to make contact with the member visits the website (step 224); the site receives the contact person's information if the contact person is not already a member, (step 23) and establishes a profile for that person based on the received information. Advantageously, the contact person is treated as a new member, so that the contact person's information becomes a new member profile on the streetfriend.com site (that is, a person wishing to make contact with a member is required to also join the site as a new member). The site then provides social networking data (step 24); that is, the site delivers information to the contact person for use in making a social connection with the member. Generally, the social networking data includes personal information regarding the member which the member has authorized to be shared with contacts visiting the site. At the minimum, said social networking data will confirm that the member is in fact a member of the website. In an embodiment, the site also causes a report to be sent to the member (step 25) alerting the member that the contact person has made a query to the site regarding the member. This report may include a personal message from the contact person along with the contact person's membership profile for the member's review. This report may be sent to the member by a means specified by the member (email, text message, etc.). Based on the member's review of the contact person's member profile, the member may make a social networking connection with the contact person via the means provided for on the website (step 26).

It will be understood that the member and the contact person may each access the streetfriend.com site using a variety of devices, both fixed (e.g., desktop, kiosk) or portable (e.g. PDA, phone, etc.).

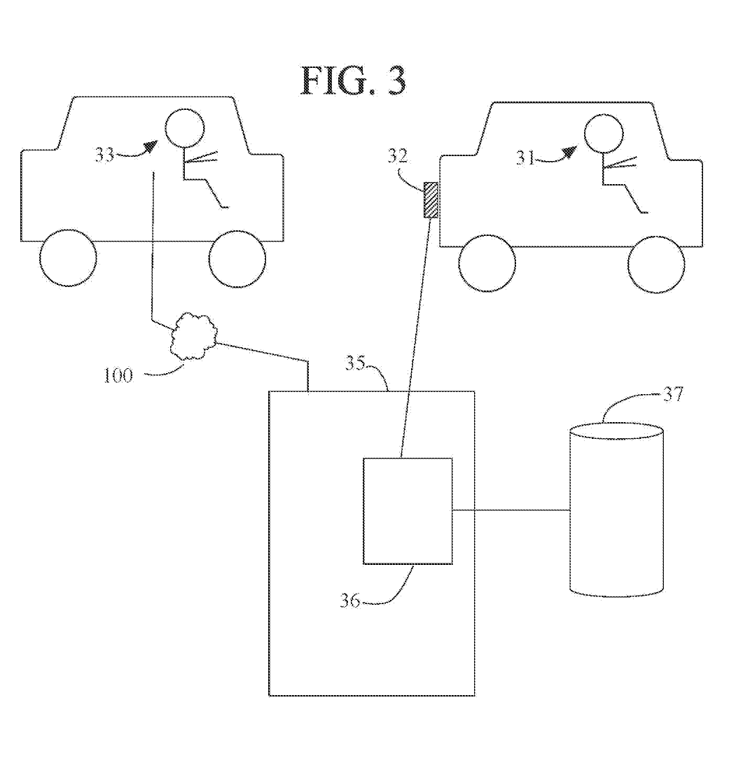

FIG. 3 schematically illustrates a system for implementing streetfriend.com, according to an embodiment of the disclosure. The streetfriend.com site 36 is hosted on a server 35; member profiles and other data may be stored on a storage device 37 external to the server. As described above, information on a bumper sticker 32 of a vehicle owned by member 31 is associated with the member's profile and with social networking data the member 31 has authorized to be shared with prospective contact persons. A prospective contact person 33 makes note of the information on bumper sticker 32, and then accesses site 36 on server 35 via the Internet 100, using any convenient device.

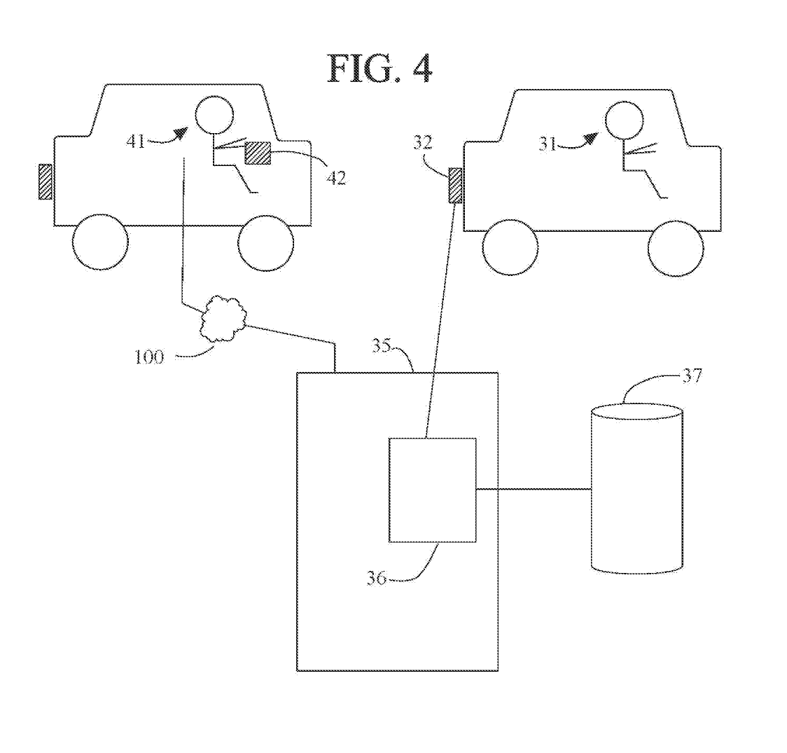

FIG. 4 schematically illustrates a system by which streetfriend.com members may connect with each other, according to another embodiment of the disclosure. In this embodiment, a member 41 is provided with a simple recording device 42 (e.g. a small tape, or flash drive recording device for keeping on a key chain or dashboard) that is suitable and safe for quick use while driving a vehicle. Member 41, wishing to make note of the information on bumper sticker 32 belonging to member 31, may then speak the license plate number or ID number of member 31 into a recorded message while driving, and then visit the streetfriend.com site to look up member 31 at a convenient time.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

1. A method for facilitating social networking, comprising the steps of:
receiving personal information from a first individual, said information including a publicly displayed identifier associated with the first individual;
storing the personal information, of which some of the personal information being retrievable using the publicly displayed identifier;
delivering, or making available to the first individual an advertisement suitable for public display;
receiving from a second individual a query in accordance with said advertisement, the query including the publicly displayed identifier;
receiving contact information from the second individual, assuming said contact information has not already been received;
retrieving the personal information of the first individual in accordance with the query;
providing to the second individual at least a portion of the personal information of the first individual;
transmitting to the first individual a message reporting the query from the second individual; and
depending upon the first individual's review of the second individual's contact information, the first individual may make a social networking connection with the second individual,
wherein said steps are performed using a computing device configured to communicate with the first individual and with the second individual via a network.

2. A method according to claim 1, wherein the publicly displayed identifier is a license plate number on a vehicle owned or operated by the first individual.

3. A method according to claim 1, wherein the advertisement includes the name, initials, or logo of a website to which the first individual submits said personal information and the second individual submits said query.

4. A method according to claim 2, wherein said advertisement is a sticker suitable for display on the vehicle.

5. A method according to claim 4, wherein said delivering step further comprises causing the sticker to be sent to the first individual in a physical form, advertising to other individuals that the first individual is a member of the website.

6. A method according to claim 1, wherein said step of transmitting to the first individual a message reporting the query.

7. A method according to claim 1, depending upon the first individual's review of the second individual's contact information, providing the second individual with the opportunity to make a social networking connection with the first individual via the means provided for on the website.

8. A method according to claim 1, further comprising the steps of:
establishing a member profile for the first individual in accordance with the received personal information stored in said storing step;
establishing a member profile for the second individual in accordance with the received contact information; and
storing the member profiles,
wherein the member profile for the second individual is established prior to providing to the second individual personal information of the first individual.

9. A method for facilitating social networking, comprising the steps of:
receiving personal information from a first individual;
assigning an identifier to the first individual;
storing the personal information, the personal information being retrievable using the identifier;
delivering to the first individual an advertisement suitable for public display;
receiving from a second individual a query in accordance with said advertisement, where the advertisement as displayed includes said identifier or information associated therewith, the query including said identifier or information associated therewith;
receiving contact information from the second individual;
retrieving the personal information of the first individual in accordance with the query;
providing to the second individual at least a portion of the personal information of the first individual;
transmitting to the first individual a message reporting the query from the second individual; and
depending upon the first individual's review of the second individual's contact information, the first individual may make a social networking connection with the second individual via the means provided for on the website,
wherein said steps are performed using a computing device configured to communicate with the first individual and with the second individual via a network.

10. A method according to claim 9, wherein the advertisement includes the name of a website to which the first individual submits said personal information and the second individual submits said query.

11. A method according to claim 10, wherein said advertisement is a sticker suitable for display on a vehicle owned or operated by the first individual.

12. A method according to claim 11, wherein said delivering step further comprises causing the sticker to be sent to the first individual in a physical form, advertising to other individuals that the first individual is a member of the website.

13. A method according to claim 9, further comprising the step of transmitting to the first individual a message reporting the query.

14. A method according to claim 9, further comprising the steps of:
establishing a member profile for the first individual in accordance with the received personal information stored in said storing step;
establishing a member profile for the second individual in accordance with the received contact information; and
storing the member profiles,
wherein the member profile for the second individual is established prior to providing to the second individual personal information of the first individual.

15. A system comprising:
a server configured to
communicate with a first individual and a second individual over a network;
receive personal information from a first individual, said information including a publicly displayed identifier associated with the first individual;
cause delivery, or making available to the first individual of an advertisement suitable for public display;
receive from a second individual a query in accordance with said advertisement, the query including the publicly displayed identifier;
receive contact information from the second individual;
provide to the second individual at least a portion of the personal information of the first individual;
transmit to the first individual a message reporting the query from the second individual; and
depending upon the first individual's review of the second individual's contact information, provide the second individual with the opportunity to make a social networking connection with the first individual via the means provided for on the website.

16. A system according to claim 15, further comprising a storage device, and wherein the server is configured to
store the personal information of the first individual, the personal information being retrievable using the publicly displayed identifier; and
retrieve the personal information of the first individual in accordance with the query.

17. A system according to claim 16, wherein the server is configured to
establish a member profile for the first individual in accordance with the received personal information stored in said storing step;
establish a member profile for the second individual in accordance with the received contact information; and
store the member profiles,
wherein the member profile for the second individual is established prior to providing to the second individual personal information of the first individual.

18. A system according to claim 16, wherein the publicly displayed identifier is a license plate number on a vehicle owned or operated by the first individual.

19. A system according to claim 18, wherein said advertisement is a sticker suitable for display on the vehicle.

20. A system according to claim 16, wherein
the server hosts a website for communicating with the first individual and the second individual, and to which the first individual submits said personal information and the second individual submits said query; and
the advertisement includes the name, initials, or logo of the website.
